(19) United States
(12) Patent Application Publication
(10) Pub. No.: US 2003/0155385 A1
(43) Pub. Date: Aug. 21, 2003

(54) Shutoff valve

(76) Inventors: Eivind Olav Sohoel, Brewster, MA (US); Robert Larnson, Medway, MA (US)

Correspondence Address: EDWARDS & ANGELL, LLP, P.O. BOX 9169, BOSTON, MA, 02209, US

(21) Appl. No.: 09/828,484

(22) Filed: Apr. 6, 2001

Related U.S. Application Data
(60) Provisional application No. 60/195,848, filed on Apr. 7, 2000.

(51) Int. Cl. B67D 3/00

(52) U.S. Cl. 222/554; 251/309

(57) ABSTRACT

A shutoff valve that in open state provides unobstructed straight flow through of the carried media. Operating without any critical metal to metal contact by utilizing elastic seals. The valve can be easily disassembled and reassembled without the use of tools, and constructed with fully interchangeable, replaceable and autoclavable parts.

The present application claims the benefit of U.S. provisional application No. 60/195,848, filed Apr. 7, 2000, incorporated herein by reference in its entirety.

### SUMMARY OF THE INVENTION

The present invention relates to new valves. Valves of the invention provide a shut-off mechanism and preferably in the open state provide an unobstructed straight-through flow of the carried media (e.g. gas or liquid or other fluid). An elastic seal is preferably included in the valve. Preferably, the valve can be readily disassembled and assembled without the use of tools and is constructed with fully interchangeable, replaceable and autoclavable parts. Preferably valves of the invention operate through a rotary turn operation. Other aspects of the invention are discussed infra.

### BRIEF DESCRIPTION OF THE DRAWINGS

FIG. 1 is a perspective view of the disassembled valve.

FIG. 2 is a cross section of the valve in open condition.

FIG. 3 is a cross section of the valve in closed condition.

FIG. 4 is a bottom view of the valve illustrating the rotational stop arrangement.

### DETAILED DESCRIPTION OF THE INVENTION

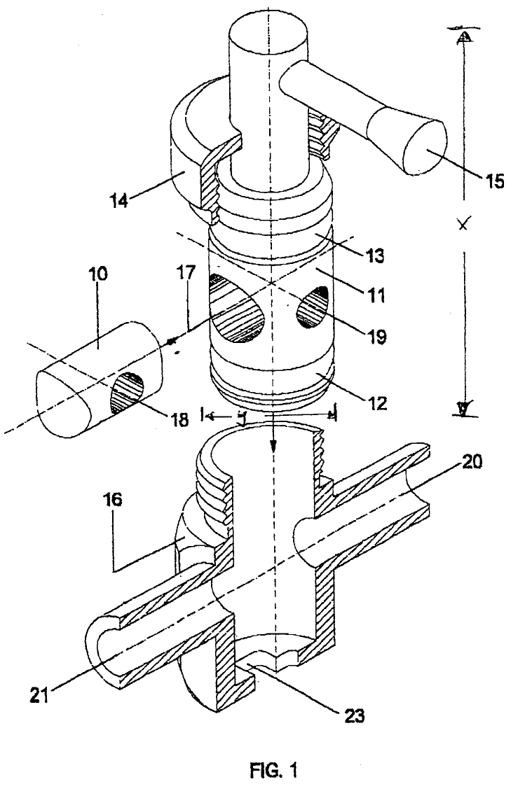

Referring to FIG. 1, the valve consists of the main elastic seal 10, the operating spindle 11, the two O-rings 12 and 13, the cap-nut 14, the handle 15, and the main valve body 16. In assembled state, the main seal 10 is inserted in the through hole 17 in the spindle 11 so that the through hole 18 in the seal 10 is lining up with the through hole 19 in the spindle 11. The spindle assembly consisting of the seal 10, the spindle 11, the two O-rings 12 and 13, the cap nut 14 and the handle 15 are then inserted into the main valve body 16 and then locked in place by the cap nut 14.

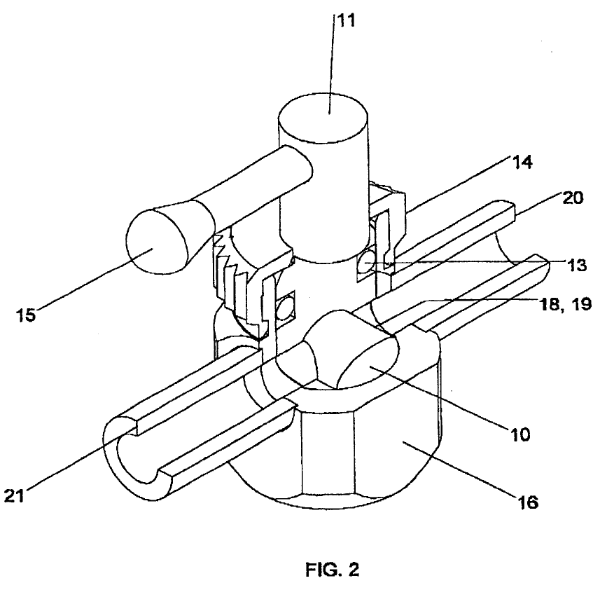

Referring to both FIG. 1 and FIG. 2, in open condition, the spindle 11 is turned by means of handle 15, so that hole 19 in spindle 11 and hole 18 in the main seal 10 are lining up with the in/out ports 20 and 21 in the main body 16. Thereby the carried media can freely flow through valve from port 20 to port 21 or from port 21 to port 20. The O-rings 12 and 13 prevent any media from leaking to the outside of the valve. O-rings also can be omitted if desired.

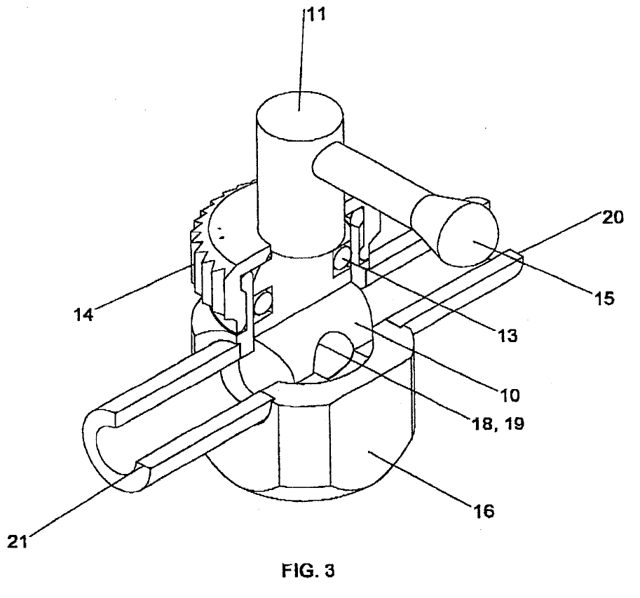

Referring to both FIG. 1 and FIG. 3, in closed condition the spindle 11 turned by means of handle 15, so that the main seal 10 is blocking the in/out port 20 and in/out port 21. In this condition the pressure difference between port 20 and port 21 is pressing the main seal 10 against the port having the lowest pressure and thereby preventing any media from flowing through the valve.

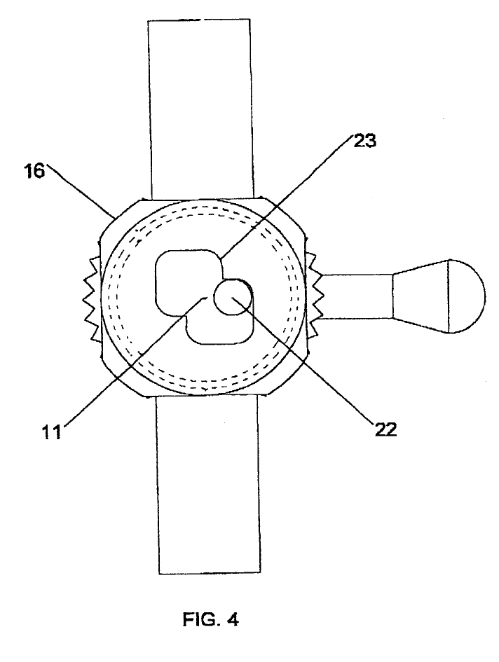

Referring to FIG. 1 and FIG. 4, a cylindrical pin 22 at the bottom end of the spindle 11 is extending into the cutout 23 in the bottom of the valve body 16. This arrangement limits the rotation of the spindle to 90° and thereby providing stop at fully open and fully closed valve.

Valves of the invention preferably contain only a single seal member, which and preferably is an elastomer material such as silicon or Viton. Preferably, the seal member has a durometer of from about 50 to about 90, more preferably from about 65 to about 85.

Valves of the invention preferably have high pressure ratings (i.e., no leakage), e.g., at least about 70 psi gas flow tolerances, more preferably about 80 or 85 psi gas tolerance. Valves of the invention preferably have a fluid flow tolerance of at least about 100 psi, more preferably about 130 psi.

Valves of the invention preferably are of stainless steel construction.

As shown in the drawings, valves of the invention provide for straight-through flow of fluid or gas.

Valves of the invention can be constructed in a variety of dimensions, including quite small dimensions. For example, referring to the valve length dimension x as shown in FIG. 1, and valve width dimension y as shown in FIG. 1. Referring to those dimensions depicted in FIG. 1, x can be suitably about 6 inches or less, more typically about 2, 3, 4, or 5 inches or less, or even more typically 0.2, 0.5, 0.75, 1.0, 1.25, 1.5 or 1.75 inches or less; y can be suitably about 2 inches or less, more typically about 2 or 3 inches or less, or even preferably 0.1, 0.2, 0.5, 0.75, 1.0, 1.25, 1.5 or 1.75 inches or less.

Valves of the invention can be used in a variety of applications. Valves of the invention are particularly useful for medical applications, such as in orthoscopic and laproscopic instruments. Valves of the invention also can be employed in analytical and dispensing devices, e.g., devices that dispense glues, various liquids and the like.

What is claimed is:

1. A valve apparatus comprising a housing comprising a flow-through path and a single seal member.

2. A valve of claim 1 wherein the valve operates by a rotary turn.

3. A valve of claim 1 or 2 wherein the valve apparatus further comprises a plurality of O-rings.

4. A valve of any one of claims 1 through 3 wherein the apparatus is contrasted of a metal.

5. A valve of any one of claims 1 through 4 wherein the valve is constructed of stainless steel.

6. A medical device comprising a valve of any one of claims 1 through 5.

7. A medical device of claim 6 wherein the medical device is a laproscopic suction device.

6. A dispensing device that comprises a valve of any one of claims 1 through 5.

7. A dispensing device of claim 6 wherein the device dispenses a liquid.

8. A dispensing device of claim 6 or 7 wherein the device dispenses glue.
